(19) United States
(12) Patent Application Publication
(10) Pub. No.: US 2008/0095193 A1
(43) Pub. Date: Apr. 24, 2008

(54) Method and Apparatus for Dynamically Adjusting the Number of Packets in a Packet Train to Avoid Timeouts

(76) Inventors: Christopher William Gaedke, Rochester, MN (US); Travis William Haasch, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/550,876

(22) Filed: Oct. 19, 2006

(51) Int. Cl. H04J 3/24

(52) U.S. Cl. 370/473; 370/389

(57) ABSTRACT

A sending device dynamically adjusts a target number of data packets in a packet train by projecting a train property in advance of timeout, and adjusts the target accordingly. Preferably, the target size of the packet train is adjusted downward by checking the number of accumulated packets in the train at some predetermined time in the timeout interval, and halving the target packet train size if the accumulated packets number less than some intermediate target. This process can be repeated more than once in the same timeout interval. The target size is preferably adjusted upwards more slowly.

### FIELD OF THE INVENTION

The present invention relates generally to digital data processing, and more particularly to data communications between different digital data entities using trains of data packets.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users. At the same time, the cost of computing resources has consistently declined, so that information which was too expensive to gather, store and process a few years ago, is now economically feasible to manipulate via computer. The reduced cost of information processing drives increasing productivity in a snowballing effect, because product designs, manufacturing processes, resource scheduling, administrative chores, and many other factors, are made more efficient.

The reduced cost of computing and the general availability of digital devices has brought an explosion in the volume of information stored in such devices. With so much information stored in digital form, it is naturally desirable to obtain wide access to the information from computer systems. The volume of information dwarfs the storage capability of any one device. To improve information access, various techniques for allowing computing devices to communicate and exchange information with one another have been developed. Perhaps the most outstanding example of this distributed computing is the World Wide Web (often known simply as the “web”), a collection of resources which are made available throughout the world using the Internet. People from schoolchildren to the elderly are learning to use the web, and finding an almost endless variety of information from the convenience of their homes or places of work.

A communications network includes multiple digital devices connected by communications links. From the perspective of the network, the devices in a network are referred to as “nodes”. A node may be a complete general purpose computer, but it may also be a special purpose digital device, or a component or sub-component of a larger digital device, such as a component or sub-component of a computer system. A network is often arranged in a topology which provides multiple communications links, and multiple paths, to each node (or each of a subset of nodes), thus providing redundancy, but it need not be so arranged.

Many communications networks, including the Internet, communicate data using packets. A packet is a self contained communications unit, containing the underlying data of interest to the sender and receiver, as well as control and routing information. The control and routing information facilitate communications processes at various levels, and allow intermediate nodes in a communications network to forward a received packet to its ultimate destination.

Sending, receiving and processing of packets have an overhead or associated cost. That is, it takes time and resources to receive a packet, to examine the packet's control information, and to determine the next action. One way to reduce the packet overhead is a method called packet training. This packet training method consolidates individual packets into a group, called a train, for transmission over a link, so that a node can process the entire train of packets at once. The word “train” comes from a train of railroad cars. It is less expensive to form a train of railroad cars pulled by a single locomotive than it is to give each railroad car its own locomotive. Analogously, processing a train of packets has less overhead, and thus may achieve better performance, than processing each packet individually.

In a typical packet training method, a sending device will accumulate packets until the train reaches a target length. Then the sender will process or transmit the entire train at once. Since the packet generation rate or arrival rate at the sender is unpredictable, in order to ensure that the accumulated packets are handled without excessive delay, a timer is started when the sender receives or generates the train's first packet. When the timer expires, the sender will discontinue accumulating packets in the train, and process or transmit it even if the train has not reached its target length.

This training method works well in times of heavy packet traffic because the timer never expires. But in times of light traffic, delay is introduced by the accumulated packets waiting in vain for additional packets to arrive to complete the train, and the ultimate timer expiration introduces additional processing overhead.

In order to accommodate changing network conditions, some packet training techniques use an adaptive target length. Generally, these techniques will decrease the target length if packets are accumulating to timeout without the train being sent, and will increase the target length if more packets arrive before timeout and could have been sent in a longer train. While these techniques provide some improvement over a fixed packet train length, they generally respond to lower network traffic by waiting for timeout, and then adjusting the packet train length. Thus, such techniques still experience timeouts in response to lower network traffic, and may experience multiple timeouts until the packet train length can be adjusted to an appropriate level.

It would be desirable to provide improved techniques for communicating data packets, and in particular for grouping data packets in trains of packets, which further reduce or avoid the occurrence of timeouts in response to lowered traffic, yet which also provide the benefits of training packets where appropriate.

### SUMMARY OF THE INVENTION

A digital device (which specifically may be a subcomponent of a larger computer system) dynamically adjusts a target number of packets to be sent in a train to another device (which specifically may be a subcomponent of the same computer system) by projecting a train property in advance of timeout, such as the size of the train or whether the train is likely to meet the target. The sending device adjusts the target accordingly. In the preferred embodiment, the sending device projects whether a target will be met before timeout, and if not, reduces the target so that the target will be or is likely to be met before timeout. It would alternatively or additionally be possible to project whether a larger train could be sent before timeout, and increase target size accordingly.

In the preferred embodiment, the target size of the packet train is rapidly adjusted downward in the event that the packet arrival rate drops by checking the number of accumulated packets in the train at some predetermined time in the interval defined by the timeout, and halving the target size of the packet train if the number of accumulated packets is less than some intermediate target, indicating that the train is not expected to reach its target size before timeout. This process can be repeated more than once in the same interval before timeout. The target size is adjusted upwards more slowly. Preferably, it is adjusted upwards by a pre-determined increment if the number of packets arriving in the interval exceeds the current target plus the increment for some number of successive intervals. I.e., it is adjusted upwards if some consecutive number of trains could have been made longer by the increment amount.

An adaptive packet training technique in accordance with the preferred embodiment thus achieves rapid adjustment of a target size of a packet train to avoid timeouts. In general, timeout tends to be rather long, so it is undesirable to wait until timeout once or multiple times to achieve adjustment of a target size. The technique disclosed herein, while not necessarily guaranteed to prevent timeout in all cases, will generally achieve a more rapid reduction of target packet train size in conditions where the arrival rate of packets drops, and will often avoid requiring any timeouts to achieve an appropriate adjustment.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level conceptual representation a network environment using packet-based communications, according to the preferred embodiment of the present invention.

FIG. 2 is a high-level block diagram of the major hardware components of a computer system for sending and receiving data packets, according to the preferred embodiment.

FIG. 3 is a conceptual illustration of the major software components of a computer system, according to the preferred embodiment.

FIG. 4 is a simplified representation of a packet train, according to the preferred embodiment.

FIG. 5 is a flow diagram illustrating the process of adding a packet to a packet train, according to the preferred embodiment.

FIG. 6 is a flow diagram illustrating the process of checking the rate of packet accumulation in a packet train to adjust a packet train target size, according to the preferred embodiment.

FIG. 7 is a flow diagram illustrating the process of responding to a packet train timeout, according to the preferred embodiment.

### DETAILED DESCRIPTION OF THE PREFERRED EMBODIMENTS

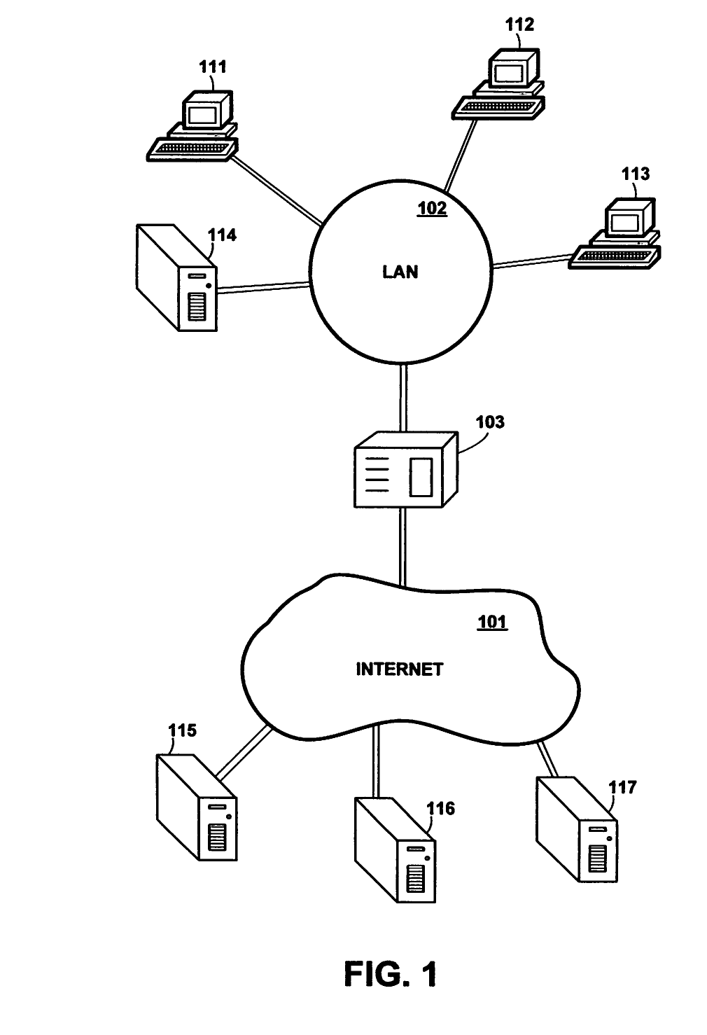

Referring to the Drawing, wherein like numbers denote like parts throughout the several views, FIG. 1 is a high-level illustration of a network environment using packet-based communications, in accordance with the preferred embodiment of the present invention. As shown in FIG. 1, a local area network (LAN) 102 is coupled to the Internet 101 through a router 103. Router 103 serves as an access node for nodes 111-114 attached to LAN 102. Nodes 111-114 may be any type of digital data processing device which can send and/or receive packets for transmission on LAN 102. For illustrative purposes, FIG. 1 shows three interactive desktop workstations 111-113 and a server system 114 attached to LAN 102. Any of these systems may communicate with one another via LAN 102, or may communicate with any of various remote systems 115-117 coupled to the Internet by routing communications via LAN 102 and router 103.

Data communicated over LAN 102 and Internet 101 is sent in packets. A packet is a self contained data unit of a fixed size for transmission on a network, having embedded information necessary to route the packet via the network to its ultimate destination. A routing protocol, such as the Transport Control Protocol/Internet Protocol (TCP/IP), specifies the format of the packet and how routing is determined.

It will be understood that FIG. 1 is intended as a conceptual illustration a network environment which includes the Internet, and that in reality the number of nodes and connections on the Internet is vastly larger than illustrated in FIG. 1, and that the topology of the connections may vary. Furthermore, it will be understood that there may be further hierarchies of types of connections and forms of access, which are not shown in FIG. 1 for clarity of illustration. E.g., there may be multiple local area networks having multiple gateway routers forming multiple redundant connections to Internet backbone routers, and so forth. The number and type of devices attached to LAN 102 and to the Internet may vary, and is typically larger than shown in the conceptual illustration of FIG. 1. Moreover, although desktop workstations and a single server are illustrated as attached to LAN 102 in FIG. 1, it will be understood that any digital data processing device having a suitable interface might be connected to LAN 102, and this may include both single user and multi-user general purpose computer systems as well as specialized digital data devices, such as data storage subsystems, printers and other data output devices, manufacturing or environmental control systems, monitoring systems, and so forth, and may also include interfaces to portable devices.

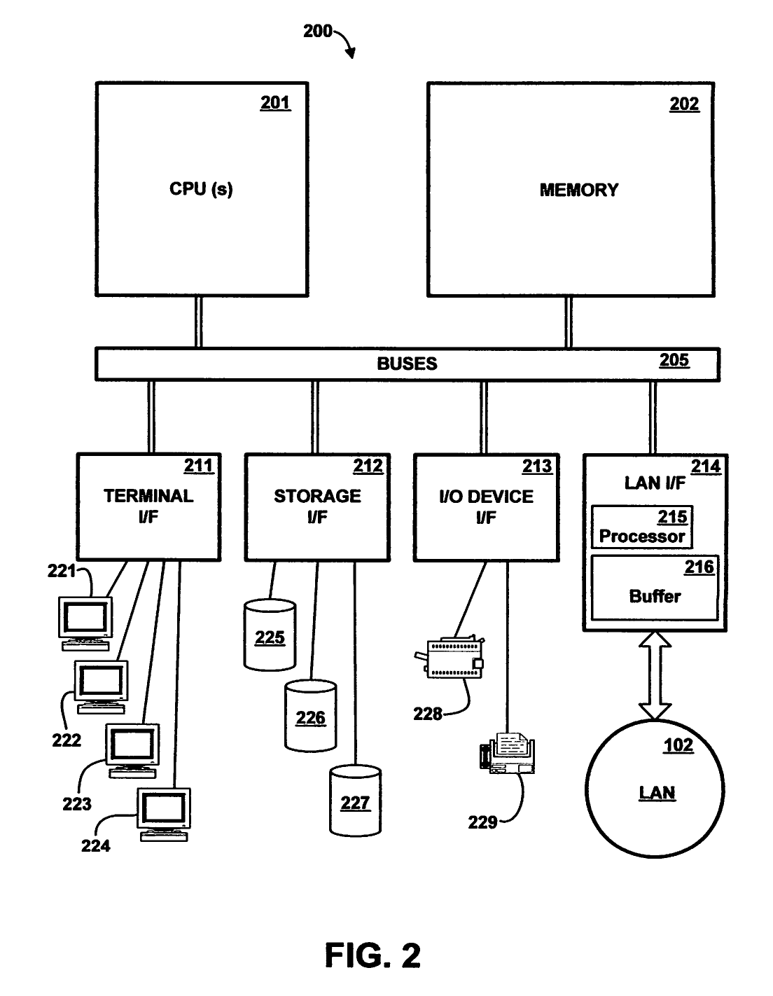

FIG. 2 is a high-level block diagram of the major hardware components of a computer system 200 which communicates with other systems over LAN 102 and the Internet using packets, according to the preferred embodiment. CPU 201 is at least one general-purpose programmable processor which executes instructions and processes data from main memory 202. Main memory 202 is preferably a random access memory using any of various memory technologies, in which data is loaded from storage or otherwise for processing by CPU 201.

One or more communications buses 205 provide a data communication path for transferring data among CPU 201, main memory 202 and various I/O interface units 211-214, which may also be known as I/O processors (IOPs) or I/O adapters (IOAs). The I/O interface units support communication with a variety of storage and I/O devices. For example, terminal interface unit 211 supports the attachment of one or more user terminals 221-224. Storage interface unit 212 supports the attachment of one or more direct access storage devices (DASD) 225-227 (which are typically rotating magnetic disk drive storage devices, although they could alternatively be other devices, including arrays of disk drives configured to appear as a single large storage device to a host). I/O device interface unit 213 supports the attachment of any of various other types of I/O devices, such as printer 228 and fax machine 229, it being understood that other or additional types of I/O devices could be used.

Local Area Network interface (or “LAN adapter”) 214 supports a connection to one or more external networks, and particularly to LAN 102, for communication with one or more other digital devices. LAN interface 214 includes an internal processor 215 which controls the operation of the LAN interface, and a buffer 216 for temporarily storing data packets. Outbound data packets may be received from CPU 201 and/or memory 202 via communications bus 205, and stored temporarily in buffer 216, for outbound transmission to the LAN. Similarly, inbound data packets may be received from the LAN into buffer 216, and later sent via communications bus 205 to memory 202 or CPU 101. Although buffer 216 is shown as a single unitary entity, it may be partitioned into multiple storage spaces. Computer system 200 of the preferred embodiment contains at least one LAN adapter 214. It may optionally contain multiple LAN or other communications adapter. Where system 200 contains multiple adapters, one or more than one may be coupled, directly or indirectly, to the Internet, and these adapters may connect to the same or different local area networks, or the same or different routers or gateways.

It should be understood that FIG. 2 is intended to depict the representative major components of system 200 at a high level, that individual components may have greater complexity than represented in FIG. 2, that components other than or in addition to those shown in FIG. 2 may be present, and that the number, type and configuration of such components may vary, and that a large computer system will typically have more components than represented in FIG. 2. Several particular examples of such additional complexity or additional variations are disclosed herein, it being understood that these are by way of example only and are not necessarily the only such variations.

Although only a single CPU 201 is shown for illustrative purposes in FIG. 2, computer system 200 may contain multiple CPUs, as is known in the art. Although main memory 202 is shown in FIG. 2 as a single monolithic entity, memory 202 may in fact be distributed and/or hierarchical, as is known in the art. E.g., memory may exist in multiple levels of caches, and these caches may be further divided by function, so that one cache holds instructions while another holds non-instruction data which is used by the processor or processors. Memory may further be distributed and associated with different CPUs or sets of CPUs, as is known in any of various so-called non-uniform memory access (NUMA) computer architectures. Although communications buses 205 are shown in FIG. 2 as a single entity, in fact communications among various system components is typically accomplished through a complex hierarchy of buses, interfaces, and so forth, in which higher-speed paths are used for communications between CPU 201 and memory 202, and lower speed paths are used for communications with I/O interface units 211-214. Buses 205 may be arranged in any of various forms, such as point-to-point links in hierarchical, star or web configurations, multiple hierarchical buses, parallel and redundant paths, etc. For example, as is known in a NUMA architecture, communications paths are arranged on a nodal basis. Buses may use, e.g., an industry standard PCI bus, or any other appropriate bus technology. While multiple I/O interface units are shown which separate system buses 205 from various communications paths running to the various I/O devices, it would alternatively be possible to connect some or all of the I/O devices directly to one or more system buses.

Computer system 200 depicted in FIG. 2 has multiple attached terminals 221-224, such as might be typical of a multi-user “mainframe” computer system. The actual number of attached devices may vary, and the present invention is not limited to systems of any particular size. Computer system 200 might alternatively be a single-user system such as “personal computer”. User workstations or terminals which access computer system 200 might also be attached to and communicate with system 200 over network 230. Computer system 200 may alternatively be a system containing no attached terminals or only a single operator's console containing only a single user display and keyboard input. Furthermore, while certain functions of the invention herein are described for illustrative purposes as embodied in a single computer system, these functions could alternatively be implemented using a distributed network of computer systems in communication with one another, in which different functions or steps described herein are performed on different computer systems.

While various system components have been described and shown at a high level, it should be understood that a typical computer system contains many other components not shown, which are not essential to an understanding of the present invention. In the preferred embodiment, computer system 200 is a computer system based on the IBM i/Series™ architecture, it being understood that the present invention could be implemented on other computer systems.

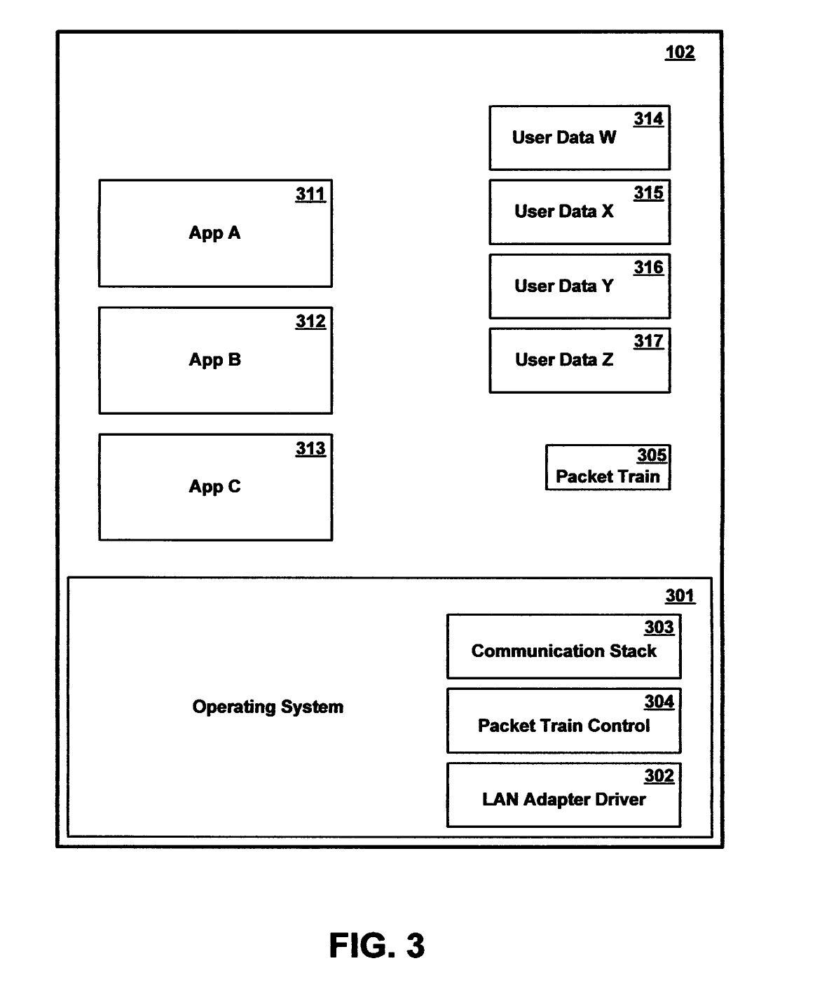

FIG. 3 is a conceptual illustration of the major software components of computer system 200, represented as components of memory 202, according to the preferred embodiment. Operating system 301 is executable code which executes on CPU(s) 201 and associated state data for providing various low-level software functions, such as device interfaces, management of memory pages, management and dispatching of multiple tasks, etc. as is well-known in the art. In particular, operating system 301 includes a LAN adapter device driver 302 for LAN adapter 214 of system 200. Where multiple hardware network interfaces or adapters are present, the operating system may contain multiple respective adapter drivers.

Operating system 301 further contains one or more communications stack instances 303 (of which one is shown in FIG. 3) and a packet train control function 304. Communications stack instance 303 implements a set of communications functions, which are preferably a set of TCP/IP and/or other Internet protocol functions for supporting communication over the Internet, such as IP routing. Packet train control function 304 controls the building of packet trains from multiple packets. Although LAN adapter driver 302, communications stack 303 and packet train control 304 are represented in FIG. 3 as separate entities, it will be appreciated that some or all may be combined and may be considered part of a single packet communication function.

System 200 further contains one or more user applications 311-313 (of which three are represented in FIG. 3, it being understood that the actual number may vary, and is typically much larger) which execute on CPU(s) 201, and one or more data structures 314-317 (of which four are represented in FIG. 3, it being understood that the actual number may vary, and is typically much larger) for use by user applications 311-313. User applications 311-313 communicate with remote processes over LAN 102 and/or the Internet to perform productive work on behalf of users, and are preferably associated with communications stack 303 to handle remote communications in accordance with TCP/IP or some other applicable protocol. Applications associated with a communications stack, such as user applications 311-313, typically are not part of the operating system, although it would additionally or alternatively be possible for operating system functions to communicate with remote processes.

In order to communicate with remote processes, applications 311-313 generate outbound data to be sent via communications stack 313 and receive inbound data from the communications stack. Communications stack 313 formats outbound data appropriately for transmission on the network, and in particular formats data into packets of an appropriate size, which are transmitted by LAN adapter driver 302 across communications bus 205 to LAN interface 214. LAN interface 214 may temporarily store packets in its buffer 216 before transmission to LAN 102. Incoming received packets are similarly forwarded by LAN interface 214 to LAN Adapter driver 302, data is extracted from packets and reconstituted in its original form by communications stack 313, and provided to the appropriate application.

In accordance with the preferred embodiment of the present invention, multiple outbound data packets containing outbound data generated by one or more of applications 311-313 may, in appropriate circumstances be accumulated as a single packet train 305. All packets in the packet train are sent together to LAN interface 214 over communications buses 205. Accumulation of packets in a packet train is regulated by packet train control function 304. Accumulation of packets, or “packet training”, reduces the number of times LAN adapter must be invoked to send packets, and consequently reduces an overhead burden on CPU(s) 201 and other system resources due to execution context switching, execution of the LAN adapter driver functions, bus arbitration, and so forth. The operation of the packet training control function is described in greater detail herein.

It will be understood that a typical computer system will contain many other software components (not shown), which are not essential to an understanding of the present invention. In particular, a typical operating system will contain numerous functions and state data unrelated to the transmission of data across a network, such as multi-tasking dispatch functions, memory management, interrupt handling, error recovery, and so forth.

Various software entities are represented in FIG. 3 as being separate entities or contained within other entities. However, it will be understood that this representation is for illustrative purposes only, and that particular modules or data entities could be separate entities, or part of a common module or package of modules. Furthermore, although a certain number and type of software entities are shown in the conceptual representations of FIG. 3, it will be understood that the actual number of such entities may vary, and in particular, that in a complex host system environment, the number and complexity of such entities is typically much larger.

While the software components of FIG. 3 are shown conceptually as residing in memory 202, it will be understood that in general the memory of a computer system will be too small to hold all programs and data simultaneously, and that information is typically stored in data storage devices 225-227, comprising one or more mass storage devices such as rotating magnetic disk drives, and that the information is paged into memory by the operating system as required. Furthermore, it will be understood that the conceptual representation of FIG. 3 is not meant to imply any particular memory organizational model, and that system 200 might employ a single address space virtual memory, or might employ multiple virtual address spaces which overlap.

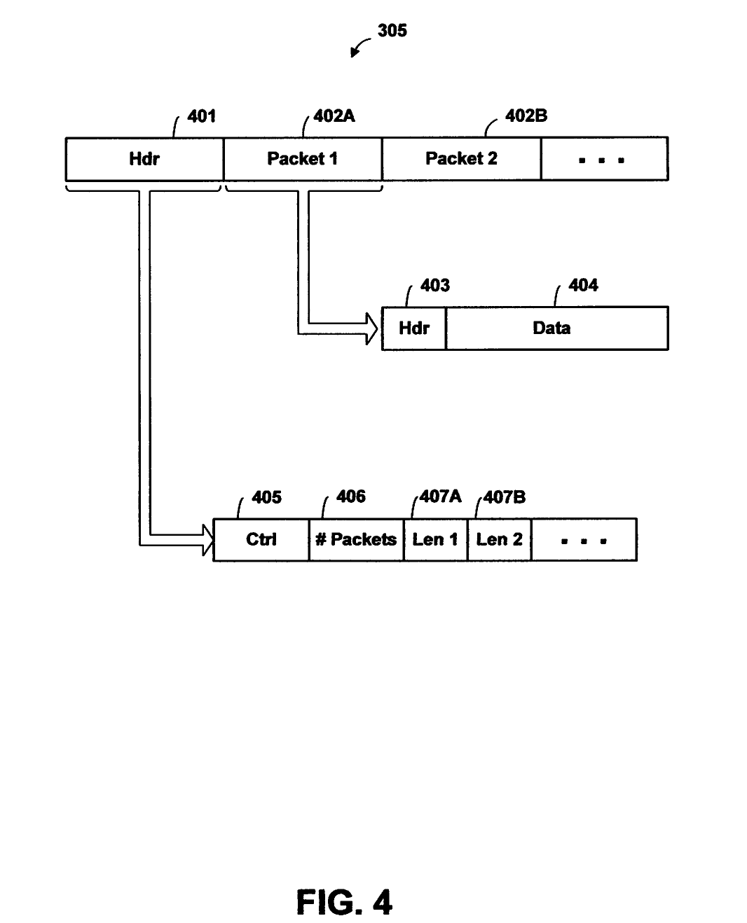

FIG. 4 is a simplified representation of the structure of a packet train 305 containing multiple packets, according to the preferred embodiment. A packet train contains a train header 401 and a variable number of packets 402A, 402B (herein generically referred to as feature 402), of which two are shown in FIG. 4. Train header 401 contains control information 405 which, among other things, identifies the data as a packet train, a number of packets field 406 which specifies the number of packets in the train, and a variable number of packet length fields 407A, 407B (herein generically referred to as feature 407), each of which corresponds to a respective packet 402 and specifies the length of a corresponding packet. In the preferred embodiment, a packet may have either 1496 bytes or 7996 bytes, but various protocols may specify packets of different sizes. If only one sized packet is allowed by the applicable protocol, then packet length fields 407 are unnecessary.

Each packet 402 within packet train 305 contains a respective packet header 403 specifying such information as a packet destination and other required control information, and packet data 404 which was generated by the originating process.

In accordance with the preferred embodiment of the present invention, outbound data generated by a process (such as one of user application 311-313) executing in CPU(s) 201 is arranged in packets by communications stack 303, and the packets are further grouped in packet trains by packet train control 304 for transmission to LAN interface 214. Packet trains are held in memory 202 as they are being built for transmission to the LAN interface. When a train accumulates a number of packets equal to a target, identified as train_max, the train is sent to the LAN interface. In order to prevent packets from waiting an inordinately long time, a timeout mechanism interrupts the processor and causes trains to be sent after a pre-determined time has elapsed, regardless of whether the train_max has been reached.

For various reasons of system performance, particularly to accommodate packets of differing size, the timeout period before sending a packet train is relatively long. Train_max is dynamically adjustable to avoid timeouts. Specifically, Train_max adjusts downwards more readily than it adjusts upwards to reflect the greater relative “cost” of waiting too long for packets to accumulate vs. not waiting long enough. Train_max is adjusted downward in advance of an actual timeout by projecting whether sufficient packets will be received to satisfy Train_max. Train_max is only adjusted upward if an excess of packets is received in the timeout interval, preferably for a consecutive number (TCL) of packet trains.

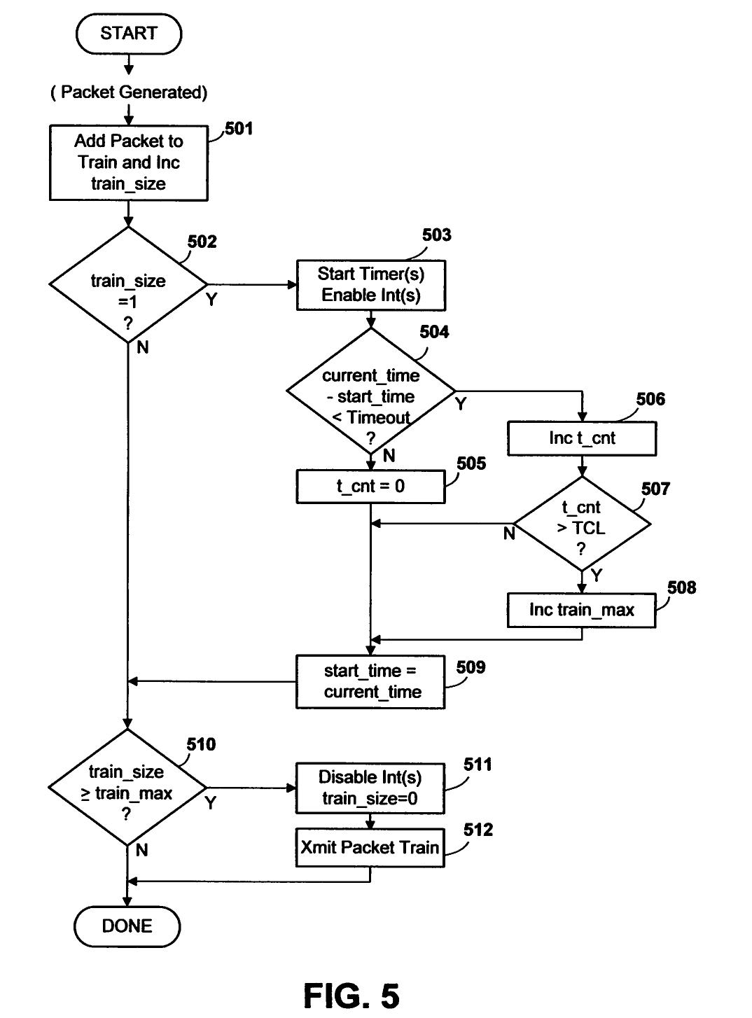

FIG. 5 is a flow diagram illustrating the process of adding a packet to a packet train as performed by packet train control function 304, according to the preferred embodiment. In this embodiment, upon adding a packet to a train, the packet train control function determines whether to immediately transmit the packet train, and whether an upward adjustment of the variable Train_max, the packet train size target, is necessary.

Referring to FIG. 4, the packet train control function is invoked when a packet is generated, e.g., when data to be transmitted to a remote process is generated by one of applications 311-314, and processed into one or more packets by communications stack 303. The generated packet is added to the packet train (which may include a initializing a new packet train with only the newly generated packet), and the variable train_size (indicating the number of packets in the packet train) is incremented by one, represented in FIG. 5 as step 501.

If train_size=1 (i.e., this is the first packet of a new train), the ‘Y’ branch is taken from step 502. In this case, one or more timers for packet train timeout and timeout check are initialized, and corresponding interrupt(s) enabled (step 503). Conceptually, there are at least two time periods, one being a packet train timeout, representing the maximum length of time a packet can wait in the packet train before being sent, and a second being a timeout check, representing the time at which packet train progress is checked and Train_max adjusted downward if necessary, the second being less that the first. The timer mechanisms are so described herein. However, it would be possible to implement these in a single timer and corresponding interrupt, which after being triggered a first time for the packet train progress check, is reset to a time value corresponding to the remainder of the timeout interval.

The packet train control checks whether the difference between the current time and start_time (the time at which the preceding packet train began accumulating packets) is less than the timeout interval (step 504). If so, then it would have been possible for the new packet to have been appended to the previous packet train without exceeding the timeout, indicating that the train_max should possibly be adjusted upward, and the ‘Y’ branch is taken from step 504. A counter designated “t_cnt” is incremented (step 506), and compared with a t_cnt limit, designated “tcl” (step 507). If t_cnt has reached the limit tcl (the ‘Y’ branch from step 507), then the ‘Y’ branch from step 504 has been taken for the last tcl consecutive packet trains. This fact is taken as a sufficient indication that train_max is too low; accordingly, train_max is incremented at step 508 (but not past some pre-determined maximum). In the preferred embodiment, train_max is simply incremented by 1; however, it would alternatively be possible to increment train_max by some other fixed amount, or by a variable amount such as a percentage. Of the increment is by more than one, then t_cnt should not be incremented until the corresponding number of packets have been received in the timeout interval of the most recently sent packet train. If the t_cnt limit has not been reached, then the ‘N’ branch is taken from step 507, by-passing step 508. If, at step 504, the ‘N’ branch is taken, then the new packet could not have been included in the previous packet train without exceeding the timeout, so t_cnt is reset to zero (step 505). The t_cnt limit can be any appropriate integer to regulate the rate of upward adjustment, and in particular could be 1, making steps 505-507 unnecessary.

After performing steps 504-508, as necessary, the start_time is reset to the current time to record the time at which the current packet train began accumulating packets (step 509). The variable start_time will not be altered again until a new packet train is begun.

The packet train control function then checks whether train_size (the number of packets in the current packet train) has reached train_max, the target maximum number of packets (step 510). If so, the ‘Y’ branch is taken from step 501. The packet timeout interrupt and timeout check interrupts are disabled, and train_size is reset to 0 (step 511). The packet train control then calls the LAN adapter driver 302 to transmit the current packet train stored in memory 202 to the LAN adapter 214 (step 512). If train_max has not yet been reached, the ‘N’ branch is taken from step 510, and the packet train control performs no further action, allowing the current packet train to remain in memory, ready to accumulate additional packets.

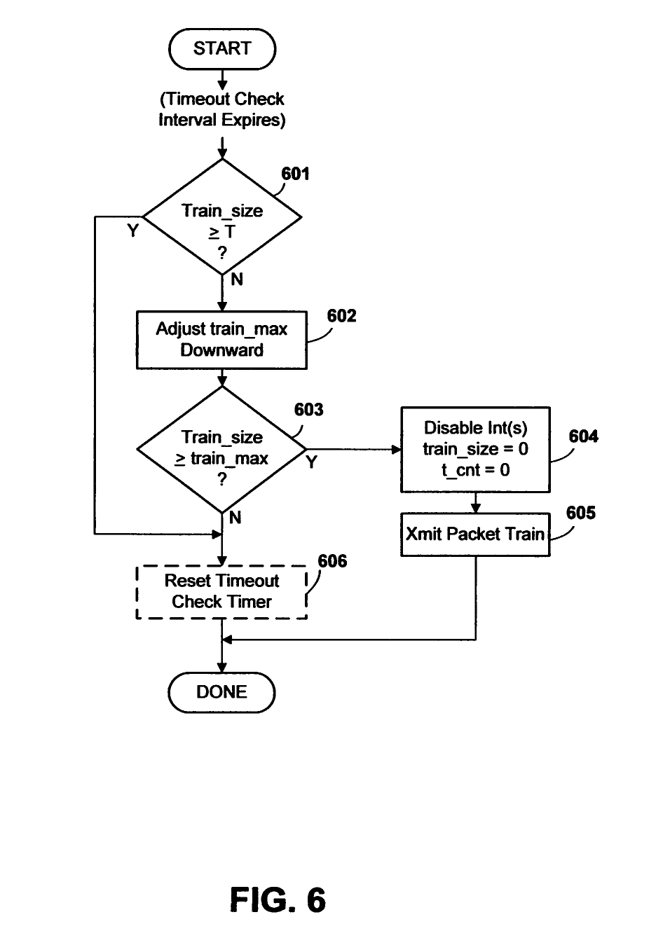

The packet train control function as described above with reference to FIG. 5 is called each time a packet is generated, and in appropriate circumstances causes a packet train to be released to the LAN adapter. Ideally, when packets are being generated at sufficient rate, the packet trains reach train_max, causing them to be sent, before a timer interrupt can occur. However, when the rate of packet production decreases, it may be necessary to reduce train_max to prevent packet train timeout. In the preferred embodiment, this is accomplished by triggering an interrupt in advance of timeout to check the current rate of packet accumulation, and adjusting train_max downward where appropriate. This procedure is depicted in FIG. 6.

Referring to FIG. 6, a function for adjusting train_max downward in the packet train control 304 is triggered by interrupt caused by expiration of a timeout check interval. Upon invoking this function, the size of the current packet train (train_size) is compared with some threshold T (step 601). If the number of packets is less than T, then the rate of packet accumulation is deemed insufficient for the current target train_max; in this case, the ‘N’ branch is taken from step 601, and steps 602-605 are performed, i.e. train_max is adjusted downward. If the number of packets is at least T, then the rate of packet accumulation is deemed sufficient, and no change will be made to the current target train_max; in this case the ‘Y’ branch is taken from step 601 to step 606, by-passing steps 602-605.

The threshold T is preferably a value selected to project a likelihood that the packet train will be filled before reaching packet train timeout. For example, the threshold T may be derived as a product K*train_max, where K is some coefficient between 0 and 1. K is generally related to the ratio of the timeout check interval to the packet train timeout interval, although it need not be exactly equal to this ratio. For example, if the timeout check interval is exactly half as long as the packet train timeout interval, then K might be approximately 0.5, so that if at least half the required packets are already in the train, it can be projected that the train will accumulate sufficient packets before timeout. However, K could be somewhat less that 0.5 or somewhat more than 0.5, depending on how aggressively it is desired to reduce train_max. In general, it is not important that T be exact. The purpose of the check at step 501 is to provide rapid adjustment of train_max in obvious cases where packets are not accumulating sufficiently rapidly. To reduce overhead, T could be derived from a table or any of various approximations, rather than performing an actual multiplication or division operation.

If the train_size does not meet the threshold T (the ‘N’ branch from step 602), the target train_max is adjusted downward accordingly (step 602). In the preferred embodiment, train_max is adjusted downward by halving, i.e. dividing the current train_max value by 2. The resultant value is rounded to an integer. Preferably, it is rounded downward (since this is easily performed in binary arithmetic by a shift operation). It will be appreciated that any of various alternative downward adjustments could be made. In one alternative variation, train_max is set to some multiple of train_size, such as 1/T*train_size. Train_max will not be adjusted below some pre-determined minimum value, which is preferably 1.

If train_size is now greater than or equal to train_max as adjusted by step 602, the ‘Y’ branch is taken from step 603. In this case, the timeout interrupts is disabled, and train_size and t_cnt are reset to 0 (step 604). The packet train control then calls LAN adapter driver 302 to transmit the packet train in its current state to the LAN adapter (step 605). If the train_size does not meet the adjusted train_max, the ‘N’ branch is taken from step 603, by-passing steps 604 and 605.

In one optional variation of the preferred embodiment, the timeout check timer is re-initialized to an appropriate timer value to cause another timeout check before expiration of the packet timeout interval, shown in FIG. 6 as optional step 606. For example, if train_max was halved at step 603, a subsequent timeout check may cause it to be halved again if the rate of packet accumulation is still sufficiently small. The timeout check could be repeated an arbitrary number of times before expiration of the packet timeout interval, thus causing a rapid reduction in the target value train_max where the rate of packet accumulation is very low.

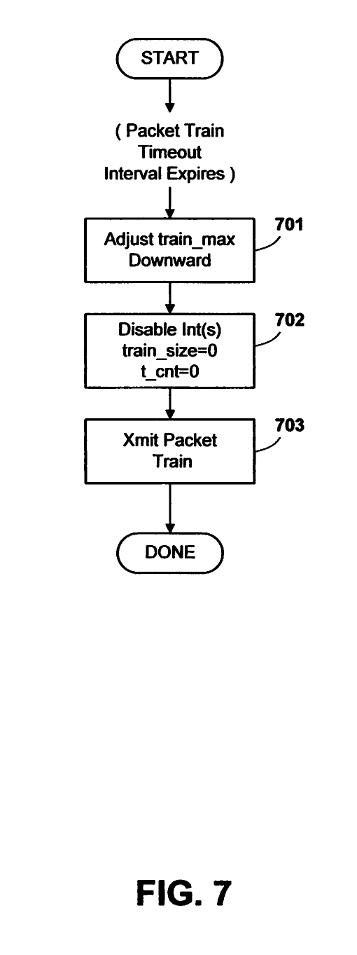

Although adjustment of train_max as described above with respect to FIG. 6 will reduce the frequency of packet train timeout, it will not necessarily eliminate it altogether. On occasion, there may be packet train timeouts. FIG. 7 shows the process of responding to an interrupt caused by a packet train timeout.

Referring to FIG. 7, a packet train timeout triggers a function in the packet train control to both adjust train_max downward and immediately send the existing packet train, regardless of its size. Train_max is adjusted downward at step 701, preferably by halving the current value of train_max, although any of various alternative adjustments could be made. The packet train timeout and timeout check interrupts are disabled, and train_size and t_cnt are reset to 0 (step 702). The packet train control function then calls LAN adapter driver 302 to transmit the current packet to the LAN adapter (step 703).

In accordance with the preferred embodiment described above, outbound packets are collected in packet trains up to a target maximum size to be transmitted from main memory to a LAN adapter, ultimately from there to be transmitted by the LAN adapter on a LAN. However, the present invention is not necessarily limited to this particular environment or application, and the dynamic adjustment of packet train size by projecting a packet train in advance of timeout, as described herein, could alternatively be applied to other environments or applications. In particular, packet training as described herein could alternatively be practiced by LAN adapter for inbound packets destined for main memory 202 or CPU 201. I.e., LAN adapter could accumulate incoming packets received over LAN 102 in packet trains in its internal buffer 216, and dynamically adjust the target size of packet trains sent to processor or memory, using the techniques described herein. The techniques described herein could alternatively be used externally of a single computer system where appropriate protocols support packet training.

In the preferred embodiment, a packet train target size is adjusted downward more readily that it is adjusted upwards. This embodiment is chosen because it is believed that the relative cost of an excessively large target size (i.e., the packets wait until timeout) is greater than the relative cost of and excessively small target size (i.e., the additional overhead of sending extra packet trains). However, in an environment in which the reverse is the case or the relative costs are more nearly equal, it would alternatively or additionally be possible to adjust the packet train target size upwards in a similar manner, e.g., by checking progress at an intermediate time in the time interval, or just before sending a packet train, and adjusting the target upwards if it appears likely that additional packets will be received before timeout.

In the preferred embodiment, a packet train size is measured solely as a number of packets in a train, regardless of packet size. It would alternatively be possible to measure a packet train size as a number of data bytes, or some other appropriate measure of size.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, volatile and non-volatile memory devices, floppy disks, hard-disk drives, CD-ROM's, DVD's, magnetic tape, and so forth. Furthermore, the invention applies to any form of signal-bearing media regardless of whether data is exchanged from one form of signal-bearing media to another over a transmission network, including a wireless network. Examples of signal-bearing media are illustrated in FIG. 2 as system memory 202, and as data storage devices 225-227.

Although a specific embodiment of the invention has been disclosed along with certain alternatives, it will be recognized by those skilled in the art that additional variations in form and detail may be made within the scope of the following claims:

What is claimed is:

1. A method for communicating using data packets arranged in packet trains containing a variable number of data packets, wherein at least some trains contain a plurality of data packets, the method comprising the steps of:
establishing a target packet train size for a packet train and a timeout interval for building a packet train in a sending device, wherein said packet train is immediately transmitted from said sending device to a receiving device either (a) if a size of said packet train reaches said packet train target size, or (b) upon expiration of said timeout interval, whichever event occurs first;
projecting a packet train property, said step of projecting a packet train property being performed before expiration of said timeout interval; and
adjusting said target packet train size to produce an adjusted target packet train size using said packet train property projected by said projecting step, said adjusting step being performed before expiration of said timeout interval.

2. The method for communicating using data packets arranged in packet trains of claim 1, wherein said target packet train size is measured as a number of packets in said packet train.

3. The method for communicating using data packets arranged in packet trains of claim 1, wherein said step of adjusting a target packet train size comprises adjusting said target packet train size downward.

4. The method for communicating using data packets arranged in packet trains of claim 3, wherein said step of adjusting a target packet train size comprises halving said target train packet size.

5. The method for communicating using data packets arranged in packet trains of claim 3, wherein said step of projecting a packet train property comprises comparing a size of said packet train to a threshold value, said threshold value being greater than zero and less than said target packet train size.

6. The method for communicating using data packets arranged in packet trains of claim 1, wherein said step of projecting a packet train property is performed at multiple different times before expiration of said timeout interval.

7. The method for communicating using data packets arranged in packet trains of claim 1, wherein said sending device and said receiving device are internal components of the same digital computer system.

8. A digital device which sends data packets arranged in packet trains containing a variable number of data packets to at least one receiving device, wherein at least some trains contain a plurality of data packets, the digital device comprising:
a buffer for temporarily accumulating packets in a packet train;
a packet train control mechanism regulating the accumulation of data packets in said packet train, said packet train control mechanism regulating a target packet train size for said packet train and a timeout interval for building said packet train
wherein said packet train control mechanism immediately causes said packet train to be transmitted to said at least one receiving device either: (a) if a size of said packet train reaches said target packet train size, or (b) upon expiration of said timeout interval, whichever event occurs first; and
wherein said packet train control mechanism dynamically adjusts said target packet train size before expiration of said timeout interval by projecting a packet train property and adjusting said target packet train size using the projected said packet train property.

9. The digital device of claim 8, wherein said packet train control mechanism is embodied as a process performed by a plurality of instructions storable in a memory of a computer system and executable by a programmable processor of said computer system.

10. The digital device of claim 8, wherein said digital device is a computer system which includes an internal bus and said receiving device, said packet trains being sent internally on said bus from a sending component of said computer system to said receiving device.

11. The digital device of claim 10, wherein said sending component is a processor of said computer system executing one or more processes performing functions of said packet train control mechanism, and said receiving device is an external communications adapter device for communication with an external packet-based network.

12. The digital device of claim 8, wherein said packet train control mechanism projects a packet train property by comparing a size of said packet train to a threshold value, said threshold value being greater than zero and less than said target packet train size.

13. The digital device of claim 8, wherein said packet train control mechanism projects a packet train property at multiple different times before expiration of said timeout interval.

14. A program product for communicating using data packets arranged in packet trains containing a variable number of data packets, wherein at least some trains contain a plurality of data packets, said program product comprising:
a plurality of instructions recorded on signal-bearing media and executable by at least one digital data processing device, wherein said instructions, when executed by said at least one digital data processing device, cause the at least one digital data processing device to perform the steps of:
establishing a target packet train size for a packet train and a timeout interval for building a packet train in a sending device, wherein said packet train is immediately transmitted from said sending device to a receiving device either (a) if a size of said packet train reaches said packet train target size, or (b) upon expiration of said timeout interval, whichever event occurs first;
projecting a packet train property, said step of projecting a packet train property being performed before expiration of said timeout interval; and
adjusting said target packet train size to produce an adjusted target packet train size using said packet train property projected by said projecting step, said adjusting step being performed before expiration of said timeout interval.

15. The program product of claim 14, wherein said target packet train size is measured as a number of packets in said packet train.

16. The program product of claim 14, wherein said step of adjusting a target packet train size comprises adjusting said target packet train size downward.

17. The program product of claim 16, wherein said step of adjusting a target packet train size comprises halving said target train packet size.

18. The program product of claim 16, wherein said step of projecting a packet train property comprises comparing a size of said packet train to a threshold value, said threshold value being greater than zero and less than said target packet train size.

19. The program product of claim 14, wherein said step of projecting a packet train property is performed at multiple different times before expiration of said timeout interval.

20. The program product of claim 14, wherein said sending device and said receiving device are internal components of the same digital computer system.
